(19) United States
(12) Patent Application Publication
(10) Pub. No.: US 2004/0041401 A1
(43) Pub. Date: Mar. 4, 2004

(54) Installation for the generation of electricity

(76) Inventors: Konstantin Trenchev, Sofia (BG); Zafir Petrov, Sofia (BG)

Correspondence Address: John B Hardaway III, Nexsen Pruet Jacobs & Pollard, P O Box 10107, Greenville, SC, 29603, US

(21) Appl. No.: 10/380,897

(22) PCT Filed: Aug. 13, 2001
(86) PCT No.: PCT/BG01/00013

(30) Foreign Application Priority Data
Sep. 26, 2000 (BG) 104800

(51) Int. Cl. H02P 9/04

(52) U.S. Cl. 290/1 R

(57) ABSTRACT

The autonomous installation for generating electric power is applicable in production of electric current in large amounts according to the installed capacity, without resorting to the use of known traditional sources of energy.

The autonomous installation contains an electric generator for direct and alternating current, a device for compressed fluid, which by means of piston cylinders 16, controlled by electromagnetic valves 17, imparts a permanent swinging motion to a mounted through metal stands 7 on a massive concrete foundation 6, a Horizontal Converter of the gravitational energy into mechanical energy. This Horizontal Converter of the gravitational energy consists of a massive rectangular frame, composed of two long horizontally mounted metal beams 1 and two short, vertical metal beams 2. In the middle of the long section of the rectangular frame, by means of bearings 10, placed in bearing beds of the lower and upper metal beams, is mounted the vertical metal axle 12, to which, in the portion that is between the upper and lower metal beams, is fixed a massive eccentric 15 at an angle of 90 degrees. On the central axle 12 are mounted the rotor of the multipolar, slow-motion electric generator and the mechanisms controlling the electromagnetic valves 17 and those blocking the reverse stroke of the eccentric 15. To the lower horizontal metal beam, around the rotor 13, is immovably fixed the stator 14 of the electric generator. To one of the two vertical short metal beams 2, horizontally, at an angle of 90 degrees, are mounted two lateral metal arms 8 with same dimensions, shape and weight, oriented in oposite directioins (left and right), to the free ends of which are movably connected the ends of the pistons for compressed fluid 16, which by means of continual thrusts swing the whole metal frame, and from there, of the rotor 13 of the electric generator. In the cases when a high-revolution classical electric generator is used, the rotation of the rotor is accomplished indirectly, through a system of belt, chain or gear transmissions, calculated to attain the required revolutions.

### FIELD OF THE INVENTION

The invention concerns an autonomous installation for generating electric power, able to produce, according to the size of the installation, a large volume of electric power, without recourse to traditional energy sources.

### BACKGROUND OF THE INVENTION

Basically, electric power is produced by two different methods: indirectly—by converting the energy of different natural sources such as petroleum, natural gas, coal, uranium, geothermal energy, wind, solar energy, initially into mechanical energy that drives turbines or combustion engines, which in turn rotate electric generators. And directly, by converting the chemical or light energy into electric power. No device to convert the gravitational energy into mechanical to be further converted into electric power is known to science and technology. To a certain extent this energy is utilized in the hydraulic power stations.

There is a device, patented as DE 3625341 A1, that converts the gravitational energy into mechanical torque energy.

The disadvantages of the known devices for production of electric power are: the depletion of non-recoverable natural energy resources on one hand, and on the other hand the serious harm to human health and, indeed, to all the living creatures caused by the pollution of the environment as a consequence of the use of those energy resources. The natural sources of energy are exploited to a degree that irreversibly disturbs the balance in Nature. The use of energy resources such as wind, sun, high tides etc. is still in an initial stage of development and represents a small percentage of the total energy, produced. Despite improvements in energy efficiency, the demand for electric power is dramatically increasing, owing to the rise in living standards, and the new developments in technology and not least the population explosion.

### BRIEF SUMMARY OF THE INVENTION

The purpose of the invention is to create an autonomous installation for generation of electric power that will convert gravitational energy into mechanical energy, which will then rotate an electric generator for direct or alternating current.

This is achieved by constructing an autonomous installation for production of electric power, that consists of an electric generator, a device for compressed fluid, which by means of piston cylinders controlled by electromagnetic valves, set in a permanent swinging motion a Horizontal Converter of gravity into mechanical energy, the Converter being mounted on a massive concrete foundation. The actual Gravitational converter represents a massive rectangular metal frame, consisting of two massive horizontal metal beams, placed one above the other. To their ends at an angle of 90 degrees are firmly and immovably fixed two short, massive, vertical metal beams. The long horizontal and the short vertical beams form an extremely sturdy rectangular metal frame. In the middle portion of the short vertical metal beams are mounted solid metal axles pointing outwards from the metal frame. By means of bearings, these axles are set in two solid, firmly fixed to the concrete foundation, supporting pivots. This design of the frame, by means of bearings fitted to the stationary stands (pivots) achieves the mobility of the frame in a vertical plane.

To one of the two short vertical metal beams of the frame are mounted horizontally metal arms with equal length, their free ends being directed respectively to the left and right. The structure described represents a balance whose pivots are the metal axles, by means of which the metal frame is movably fixed to the immovable supporting stands by means of bearings, the arms of the balance being the left and the right arms, which have identical dimensions, shape and weight. Precisely in the middle portion of the metal frame an axle is vertically mounted, which by means of bearings is fixed to the upper and lower horizontal beams. To the middle of the same central axle, at an angle of 90 degrees, is fixed an eccentric—one of its ends is free, the other is firmly fixed to the central axle. To the free end of the eccentric is mounted a massive weight. At each inclination of the balance to the left or right, which is accomplished by pistons of cylinders for compressed fluid, movably connected to the ends of the right and left shafts, the eccentric turns in the direction just selected and keeps rotating until the balance is forcibly swinging due to the impulses from the pistons of cylinders for compressed fluid. The movement of the eccentric is accomplished in a horizontal plane and stops only after we cut the injection of compressed fluid into the piston cylinders, which work alternately.

The rotational motion of the central axle is used for setting in motion of an electric generator in two ways: directly, when the rotor of a multipolar, slow-motion electric generator is mounted directly to the central axle, while the stator is fixed to one of the horizontal metal beams of the frame; and indirectly, through a system of belt, chain or gear transmissions in the cases when we have at our disposal only a high-revolution classical electric generator whose effective revolutions far exceed the revolutions of the central axle. In this case, the electric generator is mounted outside the horizontally swinging Gravitational converter.

The advantages of the autonomous installation for generating electric power are the utilization of gravity—an unlimited and free energy resource, the elimination of ecological degradation, reduction of the costs of generating electric power, the decentralization of energy production, costs reduction from the accompanying changes in the energy transfer grid, reduction of losses of energy transfer due to shortening the distances between the point of production and the consumers, relatively easy and simple production from easily available materials, easy maintenance and repair, no health hazards, better work safety, this means of production of electric power does not depend on the vagaries of Nature, prices of the electric power remain stable, that do not depend on fluctuations in the prices of fossil fuels and raw materials, easy application of automation and computerization in the autonomous installation for generating electric power, and finally an extremely high efficiency coefficient.

### BRIEF DESCRIPTION OF THE DRAWINGS

The invention is shown in the figures below, where:

FIG. 1—A schematic top view of the installation.

FIG. 2—A schematic side and front view of the installation.

FIG. 3—A schematic side view and full view of the installation.

FIG. 4—Enlarged view of the regulating mechanisms of the installation, including the electromagnetic valves of the compressed-fluid cylinders and the device for blocking the reverse stroke of the eccentric.

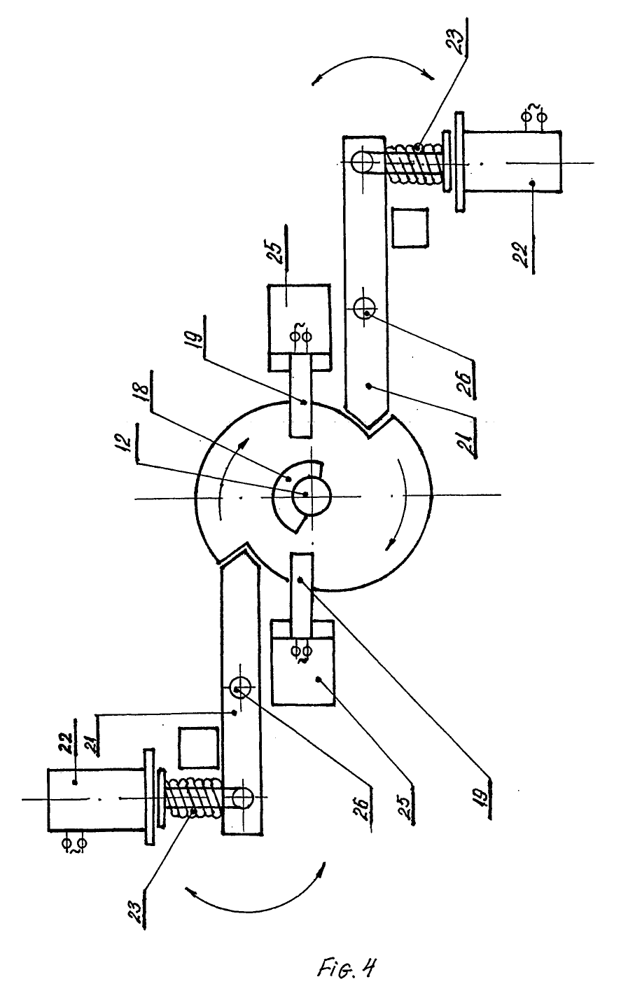

### DETAILED DESCRIPTION OF THE INVENTION

The autonomous installation for the generation of electric power represents a combination of three main units—the installation for compressed fluid (a compressor for compressed air, a hydraulic pump or a steam boiler—any one of those devices may be selected), the swinging horizontal Gravitational converter (the work of the weight is transformed into mechanical energy) and the electric generator for direct or alternating current.

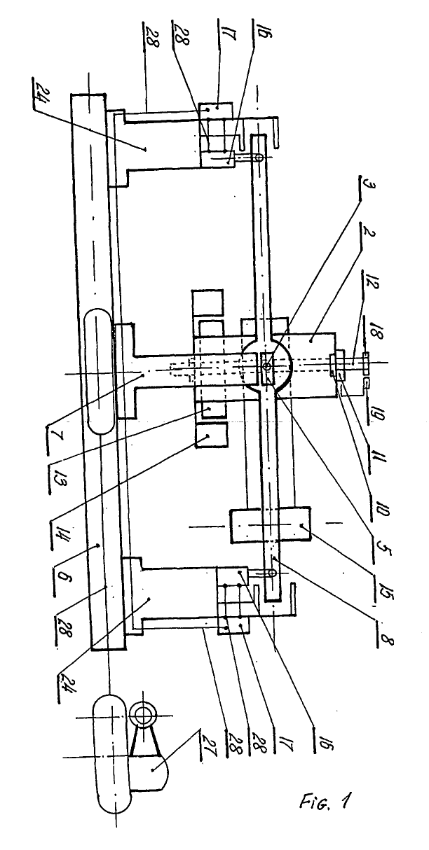

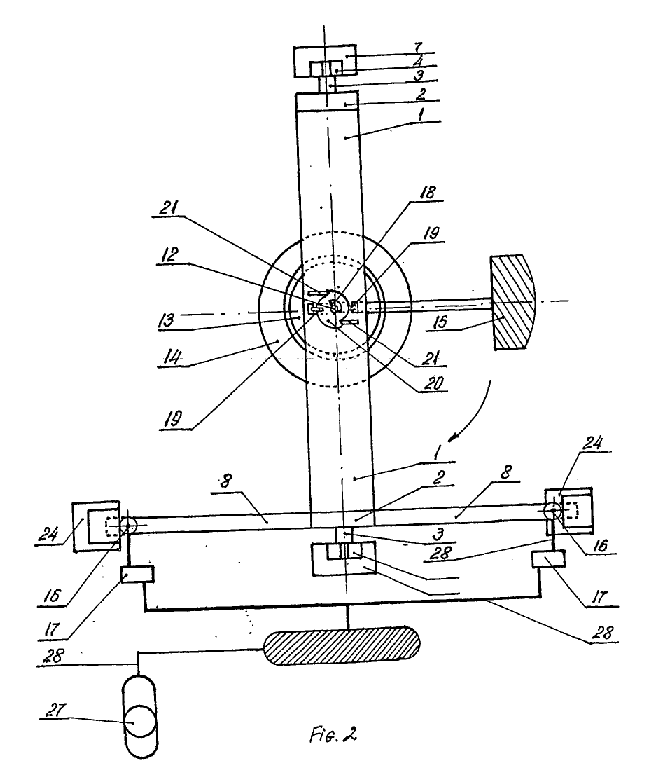

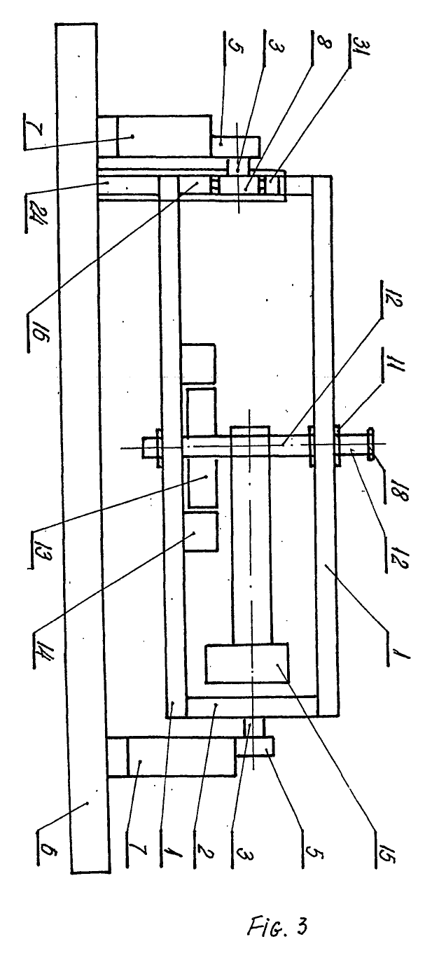

The swinging horizontal Gravitational converter—FIGS. 1, 2 and 3—represents a massive rectangular metal frame consisting of two horizontal, long metal beams placed one above the other, with same dimensions 1, and connecting them at both ends, vertically located and with same dimensions, short metal beams 2. The long horizontal beams 1 and the short vertical beams 2 are firmly fixed together and form a rectangular metal frame. In the middle of the short vertical beams 2 are mounted immovably metal axles 3, whose free ends are directed outwards from the metal frame. At the free ends of those horizontal metal axles are press-fitted bearings of corresponding size 4. These bearings, after being fitted in suitable bearing beds 5, which are mounted in immovably fixed to the concrete foundation 6 metal stands 7, asure the mobility of the metal frame in the vertical plane. The movement, that the metal frame can accomplish relative to the stationary metal stands 7 represents an arc, the centre of which is the imaginary axis through the centre of its bearings 4.

To one of the two short vertical metal beams 2 of the rectangular frame, at its middle part, lying horizontally, firmly and immovably, are fixed rigid arms 8 with the same shape and weight. The free end of one of the arms is directed right, and the free end of the other—left. The lengths of the left and right metal arms 8 must not be less than the half of the length of the horizontal metal beams 1 of the rectangular metal frame. The structure described thus far represents a two-sided equilateral bridge (or balance), with pivoting axles 3 and arms—the left and the right metal arms 8 that are immovably, horizontally mounted to the short vertical metal beam 2.

Precisely in the middle of both horizontal long metal beams 1, through upper and lower bearings 10, placed in bearing beds 11, is mounted vertically a massive metal central axle 12, whose two ends protrude outside the metal beams 1 (above and below them, respectively). In case of direct coupling of a multipolar, slow-motion electric generator to the swinging horizontal Gravitational converter, the rotor of the electric generator 13 is located in the lower part of the central axle 12, above the lower horizontal metal beam 1, while the central axle 12 goes through it. The rotor 13 and the central axle 12 are firmly and immovably fixed to each other, and when the central axle 12 is rotating, it also rotates the immovably connected to it rotor of the electric generator 13.

The stator 14 of the multipolar, slow-motion electric generator is located around the rotor 13, and is fixed immovably to the lower metal beam 1. With this mounting, the multipolar, slow-motion electric generator is placed inside the metal frame and is firmly fixed to it—directly to the frame by means of the stator 14, and indirectly, through its rotor 13 and the central axle 12.

In another design, when one does not have not at one's disposal a multipolar, slow-motion electric generator, a system of belt, chain or gear transmissions may be used for increasing the relatively low, but powerful revolutions of the central axle 12 up to the required 1500 or 3000 revolutions that are needed for the functioning of the classical and widely used quick-revolution electric generators. In those cases, the belt pulley is fixed immovably to the upper end of the central axle 12 that protrudes above the upper horizontal metal beam 1.

To the middle portion of the central axle 12, at an angle of 90 degrees, immovably and firmly is fixed a metal arm, to the free end of which is mounted a massive weight—the eccentric 15. Due to it immovable fixing to the central axle 12, when the eccentric 15 is set into rotation, it rotates also the central axle, and so, the rotor 13 of the electric generator.

Both ends of the metal arms 8 are movably connected with the piston ends of the cylinders for compressed fluid 16. The bases of cylinders 16 are fixed to solid lateral metal stands 24. The compressed fluid is delivered into the piston cylinders 16 through electromagnetic valves 17, which at the right moment are either providing injection of the compressed fluid into the piston cylinder 16, or are providing the ejection of the compressed fluid from the piston cylinder 16, when it has accomplished its work.

The control of the electromagnetic valves 17 is performed by a special electromagnetic device located in the uppermost part of the central axle 12, the part that is above the upper horizontal beam 1. This electromagnetic device includes a specially shaped steel flange 18 which is slipped over the upper end of the central axle 12 and fixed firmly to it. The outside part of the regulating flange 18 represents a semicircular arc. Due to its immovable fixing to the central axle 12, this regulating flange 18 rotates together with it. On both sides of the regulating flange 18, very close to it, on stationary stands 25, opposite to each other, are mounted electromagnetic breakers 19. In rotation, the laterally protruding metal portion of the regulating flange 18, that has the shape of a semicircular arc, passes by the electromagnetic breakers 19, without, however, touching them. As a result of this, when the protruding portion of the regulating flange 18 passes by the electromagnetic breaker 19, the electric circuit closes, and this switches on the respective electromagnetic valve 17.

Above the point where the central axle 12 protrudes through the upper horizontal metal beam, at a small distance, is mounted a device which is used to block the reverse stroke of the eccentric 15, and respectively of the central axle 12, and thence, of the electric generator. This device consists of a specially shaped blocking metal flange 20, two movable metal wedges 21, which accomplish a movement representing an arc, and in this way, either stick to, or respectively move away from the blocking metal flange 20. The movement for depressing the wedges 21 into the flange is carried out actively by means of the electromagnets 22, which become operational through electric current from the generator of the installation. The retraction of the metal wedges 21 away from the blocking flange 20, is performed passively by springs 23, which are fixed exactly on the opposite side of the fixing of the electromagnet 22 to the metal wedge 21.

At the upper end of the lateral metal stands 24, to which are fixed the piston cylinders for compressed fluid 16, on special massive metal plates are mounted pneumatic shock absorbers 31. By means of a screw, those shock absorbers 31 may be moved upwards and downwards for accurate adjustment.

The first technical operation that has to be performed in order to put into operation the autonomous installation for power production is to start the operation of the device for compressed fluid. When as the compressed fluid used is air, the device for its compression is a compressor 27, it is operated by a DC or AC electric motor, or an IC engine. In case of use of hydraulic liquid, the respective machines for increasing its pressure are employed; when the compressed fluid used is water steam, the device is a steam boiler.

After the work fluid reaches the necessary pressure, moving along the especially manufactured fluid piping, it reaches the electromagnetic valves 17. At a moment determined by the device for their regulation, the first one of them opens the aperture for the compressed fluid, whereby it is injected into the piston cylinder 16, and, applying pressure on its piston, sets it in motion. Because the end of the piston is joined with the metal arm 8, this, caused by the movement of the compressed fluid, leads to the lifting of the respective metal arm 8, and to lowering of the other metal arm 8 relative to the horizontal plane, i.e., the balance rises at one end and descends at the other. Since the metal arms 8 are firmly and immovably fixed to one of the two short vertical beams of the metal frame, their movement results in the inclination of the whole metal frame in the respective direction, and from there, that of the central axle 12 which is connected to it by means of the bearings 10. In this situation, the eccentric 15, when it is on the side of the lifting metal arm 8, rises above the horizontal plane and due to the force of the weight of its own mass, revolves, aiming to reach the lowest possible point which is exactly 180 degrees away from the highest point (top dead center) and is located below the horizontal plane. At this movement from the highest point to the lowest point (bottom dead center), the eccentric 15 describes a parabolic curve. When the eccentric 15 reaches the lowest point (bottom dead center), the device regulating the electromagnetic valves closes the electric circuit of the other electromagnetic breaker 19 and the other electromagnetic valve 17 is actuated. As a result, the metal arm 8 which is under the horizontal plane, is raised by the piston of the respective cylinder above the horizontal plane, while the other metal arm 8 descends and drops below the horizontal plane. In this way, the eccentric 15 is again above the horizontal plane and due to the developed inertia continues its movement again from the highest to the lowest point which is at 180 degrees from its location at that moment. The moment it is reached, the electromagnetic valve 17 is again actuated and the metal arm 8 which is below the horizontal plane, rises above it, while the eccentric 15 continues its rotational movement from the highest to the lowest point, gradually increasing its speed, i.e its revolutions. The rate of the revolutions depends on the speed the piston cylinders 16 and the connected to them electromagnetic valves 17 operate at. Due to the fact that the eccentric 15 is connected with the central axle 12, in the course of its movement along a circle, it rotates also the axle, and through the central axle 12, all connected with it additional devices, and, necessarily, the rotor 13 of the electric generator.

All things considered, in the swinging Horizontal Gravitational converter two movements at right angles to each other are effected. The swinging movement effected in the vertical plane is imparted as the result of applying an external force, expressed in the consecutive thrusts by the pistons of the cylinders with compressed fluid 16. This movement leads to consumption of energy supplied from an external source. The swinging of the horizontal gravitational converter in a vertical plane causes on its side a rotational movement of the eccentric 15 in a horizontal plane. This rotational movement results in exerting a powerful torque on the central axle 12, which is used to put in motion the rotor 13 of electrical generator (DC or AC current).

Due to the large mass of the eccentric 15, as well as of the whole swinging structure, it is necessary to use air or combined shock absorbers 31, which will gradually slow down and later stop the movement of the metal arms 8, just before reaching the minimal height to which they are lifted by the pistons 16 of the cylinders for compressed fluid. In this way are avoided unwanted vibrations, that arise from the sharp interruption of the movement of the piston of the compressed fluid 16 when it reaches the Top Dead Center or Bottom Dead Center. To overcome the unwanted vibrations contribute also the special support pads 32 located at suitable height—they are pressed by the metal arm 8 just before the piston of the compressed fluid cylinder 16 reaches its dead center. Due to their influence on the movement of the metal arms 8, the three mechanisms, namely: the piston compressed fluid cylinders 16, the air shock absorbers 31 and the support pads 32, are mounted on the lateral metal stands 24 employing special screw designs that allow adjusting the heights of their positions to achieve a precise manual adjustment.

The dynamics of the swinging Gravitational converter, and from there the rate characteristics of the rotational movement of the central axle 12 are easily described and they are calculated according the formulae for force F, work A, power P and torque M. In tables 1, 2 and 3 are shown the values of F, A, P and M for three-eccentrics 15 with different lengths, as well as for different weight of the eccentric 15—varying from 50 to 500 kg.

Commenting values of the different quantities obtained, it has to be noted that they are calculated without taking into consideration certain losses of energy, proceeding from the friction in the bearings 10, as well as the air resistance that the eccentric 15 has to overcome during its movement. Those losses do not exceed but a few percent and therefore do not significantly affect the power P and the torque M of the Gravitational converter. Besides, for the sake of theoretical convenience, the weight of the eccentric 15 is calculated as one of a mass point that is maximally away from the central axle 12—respectively at 1, 2 and 3 meters. The calculations were made for 120 revolutions per minute /rpm/ of the central axle 12. With the manufactured prototype, those values were exceeded and they are being permanently improved following technical perfection. Increasing the rpm has an extremely positive effect on the force, work, power and torque considered in the tables.

TABLE 1
/ECCENTRIC—1 m 120 rpm/

| WEIGHT | FORCE F | WORK A | POWER P | TORQUE |
|---|---|---|---|---|
| (kg/) | (N) | (J) | (W) | (N/m) |
| 50 | 628 | 7887 | 7887 | 628 |
| 100 | 1256 | 15775 | 15775 | 1256 |
| 150 | 1884 | 23661 | 23661 | 1884 |
| 200 | 2512 | 31550 | 31550 | 2512 |
| 250 | 3140 | 39435 | 39435 | 3140 |
| 300 | 3768 | 47322 | 47322 | 3768 |
| 350 | 4396 | 55209 | 55209 | 4396 |
| 400 | 5024 | 63101 | 63101 | 5024 |
| 450 | 5652 | 70983 | 70983 | 5652 |
| 500 | 6280 | 78870 | 78870 | 6280 |

TABLE 2
/ECCENTRIC—2 m 120 rpm/

| WEIGHT | FORCE F | WORK A | POWER P | TORQUE |
|---|---|---|---|---|
| (kg/) | (N) | (J) | (W) | (N/m) |
| 50 | 1256 | 31550 | 31550 | 2512 |
| 100 | 2512 | 63101 | 63101 | 5024 |
| 150 | 3768 | 94650 | 94650 | 7536 |
| 200 | 5024 | 126202 | 126202 | 10048 |
| 250 | 6280 | 157750 | 157750 | 12560 |
| 300 | 7536 | 189303 | 189303 | 15072 |
| 350 | 8792 | 220850 | 220850 | 17584 |
| 400 | 10048 | 252405 | 252405 | 20036 |
| 450 | 11304 | 283950 | 283950 | 22608 |
| 500 | 12560 | 315500 | 315500 | 25120 |

TABLE 3
/ECCENTRIC—3 m 120 rpm/

| WEIGHT | FORCE F | WORK A | POWER P | TORQUE |
|---|---|---|---|---|
| (kg/) | (N) | (J) | (W) | (N/m) |
| 50 | 1884 | 70989 | 70989 | 5652 |
| 100 | 3768 | 141976 | 141976 | 11304 |
| 150 | 5652 | 212967 | 212967 | 16956 |
| 200 | 7536 | 283956 | 283956 | 22608 |
| 250 | 9420 | 354945 | 354945 | 28260 |
| 300 | 11304 | 425934 | 425934 | 33912 |
| 350 | 13188 | 496923 | 496923 | 39564 |
| 400 | 15072 | 567912 | 567912 | 45216 |
| 450 | 16956 | 638901 | 638901 | 50868 |
| 500 | 18840 | 709891 | 709891 | 56520 |

What is claimed is:

1. The Autonomous installation for production of electric power that includes a multipolar, slow-motion electric generator for direct or alternating current, a device for compressed fluid, connected with piston cylinders 16, controlled by electromagnetic valves 17, which in turn are controlled by a special electromechanical device, which by means of the electromagnetic valves, alternatively controls the thrust of the pistons of the compressed fluid cylinders 16, brings into continual swinging motion in respect of a horizontal plane a Horizontal Converter of the gravitational energy into mechanical one, being characterized by its consisting of a massive metal frame built of two long horizontal metal beams and two short vertical beams 2, in the middle portion of which there are mounted directed outwards of the frame metal axles 3, by means of which the metal frame through bearings is freely connected with two, placed on both its sides, massive metal stands 7, firmly fixed to a massive concrete foundation 6, and to one of the two short vertical metal beams mounted at an angle of 90 degrees, horizontally, directed in opposite directions (left and right), metal arms 8 with the same shape and weight, to the ends of which are movably joined the free ends of the pistons for compressed fluid, and in the middle of the metal frame, through the middle portion of the two long horizontal metal beams 1, is mounted by means of upper and lower bearings 10, lodged in bearing beds 11, the vertical central axle 12, to the middle portion of which, at an angle of 90 degrees is fixed the eccentric 15, which eccentric when rotated, rotates the axle, as well as the connected with its upper end mechanisms for control of the electromagnetic valves 17 and for the blocking of the reverse stroke of the eccentric 15, and in its lower end is located, above the lower horizontal beam 1, the rotor 13 of the multipolar, slow-motion electric generator, around which is situated the immovably fixed to the lower horizontal metal beam, the stator 14 of the same generator.

2. Autonomous installation for production of electric energy according claim 1, characterized by that, that the central axle by means of a system of belt, chain or gear transmissions, puts indirectly into motion a rotor of high-revolution electric generator installed outside the frames of the swinging Horizontal Converter of the gravitational energy into mechanical one.

3. Autonomous installation for production of electric energy according to claim 1, characterized by that, that the device for compressed fluid may be—for compressed air /compressor/, for increasing the pressure of hydraulic liquid /hydraulic pump/, and for water steam /steam boiler/.

4. Autonomous installation for production of electric energy according to claim 2, characterized by that, that the device for compressed fluid may be—for compressed air /compressor/, for increasing the pressure of hydraulic liquid /hydraulic pump/, and for water steam /steam boiler/.
